(19) United States
(12) Patent Application Publication
(10) Pub. No.: US 2014/0095158 A1
(43) Pub. Date: Apr. 3, 2014

(54) CONTINUOUS AMBIENT VOICE CAPTURE AND USE

(71) Applicant: Matthew VROOM, San Francisco, CA (US)

(72) Inventor: Matthew VROOM, San Francisco, CA (US)

(21) Appl. No.: 13/633,687

(22) Filed: Oct. 2, 2012

(51) Int. Cl. G10L 15/26

(52) U.S. Cl. 704/235; 704/E15.043

(57) ABSTRACT

An apparatus, system and method for continuously capturing ambient voice and using it to update content delivered to a user of an electronic device are provided. Subsets of words are continuously extracted from speech and used to deliver content relevant to the subsets of words.

### BACKGROUND OF THE INVENTION

1. Technical Field

The field of the invention is voice capture and use, and more specifically methods, apparatus, and systems for capturing ambient speech and using it to deliver content to a user.

2. Description of Related Art

Voice interactions with mobile computing devices in the prior art have been extremely limited. Voice-based digital assistants, such as Apple's Siri assistant, require manual input to trigger the voice interaction capability. Such a voice-based assistant will only respond to voice commands after, for example, a button on the mobile computing device has been pressed. These interactions are cumbersome, non-intuitive and historically less functional than hoped for by users.

### SUMMARY OF THE INVENTION

The present invention is, according to one embodiment, directed to a computer-readable-recordable storage medium storing processor-executable instructions that when executed by a processor perform: continuously capturing, through a microphone operatively coupled to a mobile computing device, substantially all human speech in range of said microphone; converting said speech to text using automatic speech recognition; continuously extracting subsets of words from said text; delivering content to a user of said mobile computing device based at least in part on at least one said subset of words; and continuously updating said content based at least in part on changes in said subsets of words.

In another embodiment which is a variation on any other embodiment of the computer-readable-recordable medium disclosed herein, said content comprises internet search results or a language trend. In still another embodiment, the delivering step of any other embodiment disclosed herein is based at least in part on non-speech information derived from said mobile computing device. In yet another embodiment, the updating step of any other embodiment disclosed herein comprises refining said content while said speech remains on a first topic, and replacing said content when said speech pivots to a second topic.

In one embodiment, the subsets of words used by any other embodiment consist essentially of at least one of nouns, verbs, adjectives, adverbs and proper names. In another embodiment, a grammar specification used by said automatic speech recognition is updated based at least in part on said content and optionally at least in part on predictive search terms received from an internet search engine.

In another embodiment, the continuously capturing step of any other embodiment further comprises continuously capturing human speech received by said mobile computing device from a remote source. In one embodiment, the content is delivered by a content-specific module.

One embodiment of the invention is a mobile computing device comprising the computer-readable-recordable storage medium of any other embodiment disclosed or claimed herein. Another embodiment of the invention is processor-executable instructions according to any other embodiment disclosed or claimed herein. In still another embodiment of the invention, a method of updating content and delivering content to a user of a mobile computing device comprising the method steps disclosed or claimed in all other embodiments herein.

The invention surprisingly overcomes several problems that have not been solved in the prior art, including the long felt need for a way to intuitively interact with a mobile electronic device using voice.

### BRIEF DESCRIPTION OF THE DRAWINGS

The novel features believed characteristic of the invention are set forth in the appended claims.

### DETAILED DESCRIPTION

The present invention continuously captures, analyzes and uses ambient human speech gathered by a mobile computing device. Embodiments of the present invention may utilize a mobile computing device which comprises a general-purpose or special-purpose computer, which may include computer hardware, as discussed in greater detail below. Some embodiments may also include computer-readable-recordable media capable of storing and executing or running computer-executable or processor-executable instructions or data structures. Such computer-readable-recordable media can be any available media that can be accessed by a general-purpose or special-purpose computer. For example, computer-readable-recordable media can include physical computer-readable storage media, such as, RAM, ROM, EPROM, EEPROM, CD-ROM, DVD, or other optical disk storage, magnetic disk storage or other magnetic storage devices, or any other medium which can be used to store program code means in the form of computer-executable or processor-executable instructions or data structures and which can be accessed by a general purpose or special purpose computer.

As used in this description and the claims, a “network” is defined as at least one data link that enables electronic data transport between computer systems or individual modules of computer systems. Individual modules of computer systems or networks are sometimes referred to as clients or nodes. When information is transferred or provided over a network or another communications connection (whether wireless, hardwired, or a combination of the two) to a computer, the computer properly views the connection as a computer-readable medium. Thus, for example, computer-readable-recordable media can also include a network or data links which can be used to transmit, provide, receive or store desired program code means or data structures in the form of computer-executable or processor-executable instructions or data structures and which can be accessed by a general purpose or special purpose computer.

Processor-executable or computer-executable instructions can comprise, for example, instructions and data which cause a general purpose computer, special purpose computer, or special purpose processing device to perform a specific function, group of functions, step or group of steps. The computer-executable instructions may be, for example, binary code, intermediate format instructions such as assembly language, or even source code. Although the subject matter has been described in language specific to structural features and/or methodological acts, it is to be understood that the subject matter defined in the claims herein is not necessarily limited to the described structural features or acts described herein. Instead, the described structural features and acts are disclosed as example embodiments of implementing the claims.

Practitioners of the present invention will appreciate that it may be practiced in network computing environments with many different types of computer systems and configurations, including, without limitation, personal computers (PCs), desktop computers, laptop computers, servers, message processors, hand-held devices, multi-processor systems, microprocessor-based or programmable consumer electronics, network PCs, minicomputers, mainframe computers, mobile telephones, PDAs, and pagers. The invention may also be practiced in distributed system environments where local and remote computer systems, which are linked (whether by hardwired data links, wireless data links, or a combination of links) through a network, both perform tasks. In a distributed system environment, program modules may be located in both local and remote memory storage devices.

In one embodiment of the present invention, a computer-readable-recordable storage medium stores and runs processor-executable instructions that, when executed by a processor perform the following steps: continuously capturing, through a microphone operatively coupled to a mobile computing device, substantially all human speech in range of the microphone; converting said speech to text using automatic speech recognition; continuously extracting subsets of words from said speech; delivering content to a user of said mobile computing device based at least in part on at least one said subset of words. Human speech is in range of a microphone when the microphone is capable of capturing the speech in a form of sufficient level and fidelity that allows an automatic speech recognition algorithm to covert the speech to text.

In one embodiment, the processor-executable instructions are stored on a computer-readable-recordable medium integral to the mobile computing device. Examples of computer-readable-recordable media integral to a mobile computing device include integrated circuits attached to printed circuit assemblies (and their equivalents) which are used to operate the mobile computing device. In other embodiments, the instructions are stored, at least in part, on a computer-readable-recordable storage medium integral to a separate computing device, including a server, a personal computer, another mobile computing device, or any other general or special purpose computer linked to the mobile computing device via a network.

In one embodiment, the step of performing automatic speech recognition to convert the speech to text is executed by instructions stored on a computer-readable-recordable medium integral to the mobile computing device. The text generally comprises substantially all words recognized by the automatic speech recognition algorithm used for the converting step. In other embodiments, the instructions are stored, at least in part, on a computer-readable-recordable storage medium integral to a separate computing device, including a server, a personal computer, another mobile computing device, or any other general or special purpose computer remote from and/or linked to the mobile computing device via a network.

Automatic speech recognition (ASR) algorithms are known in the art, such as the Hidden Markov Models. When embodiments of the present invention are used to capture the speech of two or more humans involved in a conversation, the algorithm is preferably speaker independent, but may use speaker dependent accuracy improvement features when at least one of the human voices is recognized by the algorithm. In its simplest form, the automatic speech recognition algorithm used in accordance with the present invention is a “speech-to-text” algorithm. Such an algorithm merely converts each word recognized in the digitized human speech captured through the microphone into the written form of that word. More complex algorithms will recognize and group words, phrases and sentences together, and the most complex algorithms are natural language processors. However, such functionality is not critical to the present invention in its broadest respect.

In the next step of one embodiment of the present invention, subsets of words are extracted from the text generated by the automatic speech recognition algorithm. Generally, when subsets of words are extracted from the text, the subsets exclude at least one word from said text. In a preferred embodiment, the subsets consist essentially of at least one of nouns, verbs, adjectives, adverbs and proper names. In a most preferred embodiment, the subsets exclude at least one of indefinite articles, partitive articles, conjunctions, interjections, pronouns, and prepositions. The classification or part of speech for a particular word can be determined by querying a dictionary, for example, an online dictionary or a local or remote database that stores a vocabulary with identifying information, such as part of speech and tense.

The final step in one embodiment of the present invention comprises delivering content to the user of the mobile electronic device based on at least one of the subsets of words extracted from the text. The type of content delivered to the user can vary widely depending on the known or anticipated needs of the user. Examples of content that may be delivered based on subsets of words captured by the present invention can include at least one of the following: internet search engine results, sports scores, restaurant availability or menu, weather, traffic, flight schedules, encyclopedia entries, statistics, and unit conversions.

In one embodiment, the content delivered to the user comprises internet search engine results page. In this embodiment, the at least one subset of words is used as at least one query into an internet search engine. The terms internet, web, and world wide web are used herein interchangeably to refer to the network of computer devices and content interlinked by the internet protocol suite (including TCP/IP), hypertext markup language, and associated protocols and languages. Examples of internet or web search engines include Google, Yahoo! and Bing.

In a preferred embodiment, the content delivered to the user is updated continuously. Content updates can occur according to a number of different protocols. For example, the first batch of content delivered to the user may be based on the first subset of five words extracted from the text generated by the ASR algorithm. A second, updated batch of content may then be delivered to the user based on the second subset of five words extracted from the text generated by the ASR algorithm. This process may proceed for each subsequent subset of five words.

In another embodiment, the subset of words used to deliver content is continuously updated using a First-In-First-Out (FIFO) method. In this embodiment, the subset of words used to deliver content to the user is chosen, for example, as a five word subset. The first five words extracted from the text generated by the ASR algorithm fill the subset. The next word extracted is placed into the subset, and the first word placed into the subset is removed, and the content delivered to the user is updated based on the new subset. In other embodiments, the content is only updated after a plurality of new words has been added and a plurality of old words has been removed from the subset.

A variation on this embodiment may include keeping words that are being used repetitively in the subset of words being used to deliver content even when it might otherwise be omitted under a pure FIFO process. Words that are repeated may serve as indicators of the subject being discussed, and therefore help deliver more relevant content. In other embodiments using more complex language processing algorithms, the subset and content can be updated, for example, when the beginning of a new sentence is detected. In still other embodiments, the content can be updated after a predetermined number of seconds have passed, or at other predetermined intervals.

The foregoing are merely examples of ways content can be continuously updated based on text generated by a speech-to-text algorithm. In the broadest sense of the invention, continuous updating occurs when at least one content update is delivered to the user without the user requesting the update and without prompting the user for additional instructions or commands. This process of continuously updating content on a mobile electronic device based on detected speech is unknown in the art. With all previous voice-activated assistants known in the art, the user must interface with the device and request each content update. In the present invention, the opposite occurs. Content is continuously updated until the user instructs the mobile electronic device to cease updating content. This instruction may occur by the user pressing a button on the mobile electronic device (including a virtual button on a touchscreen), or any other vocal or non-vocal command understood by the device as an instruction to cease content updates.

In another embodiment, the content delivered to the user is delivered by at least one module. In this embodiment, the modules comprise a default module and at least one content-specific module. In one example, the default module comprises a search engine module, and a content-specific module comprises a sports score module. Other examples of modules that a practitioner of the present invention may find useful include, without limitation, restaurant modules, unit conversion modules, weather modules, traffic modules, travel modules, movie and television modules, and encyclopedia modules.

Content is delivered by modules when the speech recognized by the ASR algorithm contains keywords that trigger a specific module. The module is a set of instructions that delivers content in a particular format most appropriate for the type of content delivered by that module. For example, when the ASR algorithm detects the name of a sports team, the content updated and delivered to the user based on the at least one subset of words is generated by a sports score module. The sports score module is designed to deliver sports scores in a format that is familiar and easy to read by the user. Likewise, when the name of a restaurant is recognized by the ASR, a restaurant module delivers reservation times and/or menus as the content based on the subset of words. The numbers, functions and identities of modules is not limited by the foregoing, as they are merely examples.

In another embodiment, the processor-executable instructions utilize a predictive algorithm to anticipate which words may be extracted from the speech recognized by the ASR algorithm. Predictive algorithms are known in the art and included as added functionality in many popular third party internet search engines. A predictive algorithm uses statistical analysis of the relationships of word usage in different contexts. In a preferred embodiment, a predictive algorithm is used to increase the accuracy of the ASR algorithm by using the results of the predictive algorithm as inputs into the ASR algorithm. In a most preferred embodiment, the predictive algorithm is one available on an internet search engine. For example, if the subsets of words extracted from the speech recognized by the ASR algorithm are used as queries for an internet search engine that is already equipped with predictive algorithm functionality, the processor-executable instructions can use the predicted words generated by the internet search engine to improve the accuracy of the ASR algorithm with regards to subsequent speech captured through the mobile electronic device's microphone. In another embodiment, the content delivered to the user based on the at least one subset of words, such as internet search results, are used to increase the accuracy of the ASR algorithm.

In another embodiment, the processor-executable instructions also use other information available on the mobile electronic device in determining the content updates to be delivered to the user. For example, the location of the device may be known from the Global Positioning System (GPS) coordinates of the mobile electronic device. The processor-executable instructions may then use the location of the device to deliver location-specific content that is relevant to the speech captured by the ASR algorithm. In one embodiment, the processor-executable instructions use the location of the device as an input for delivering content to the user. In particular, location information gathered from the device can be used as an input unless the subsets of words extracted from the speech indicate that the more relevant content relates to a location other than the location of the device. For example, if the speech recognized by the ASR algorithm includes references to locations other than, or geographical areas distant from, the present location of the mobile electronic device, the processor-executable instructions may lower the priority of, or disregard altogether, content related to the location of the device.

Other non-speech-derived information available on the device may include, without limitation, the time, weather conditions, calendar information, emails, text messages, completed and missed calls, and web browsing history. Any or all of this information can be used by the processor-executable instructions to deliver relevant content to the user of the mobile electronic device.

When content updates are disclosed in the present invention, it is not necessarily intended that each and every content update actually be delivered to the user. For example, the processor-executable instructions of the present invention can be running in the background while another program is running in the foreground. Also, the instructions can be running while the screen of the mobile electronic device is off. In either case, the most recent content update can be delivered to the user either when the application running the inventive instructions is brought to the foreground, or when the device's screen is turned on.

The following examples illustrate the some of the operational principles of the present invention and how a mobile electronic device would function according to one embodiment of the present invention.

### EXAMPLE 1

### Internet Search Engine Results

Two people sit down to share a meal and have a conversation. One of the participants has a mobile electronic device comprising computer-readable-recordable storage medium with processor-executable instructions that, when executed, perform the method steps of the present invention. The mobile electronic device is a mobile telephone comprising a microphone, touch screen, internal storage memory and at least one computer processor, all operably interconnected (though all are not necessarily directly connected to each other). The user of the mobile phone causes the telephone to execute the instructions by pressing a virtual button on the touch screen, which launches an application that captures speech through the microphone, runs the speech through an ASR algorithm, extracts subsets of words from said speech, and delivers continuously updated content to the user. In this simple example, the at least one subset of words are used as internet search engine queries, and the content comprises search engine results.

As the conversation progresses, a question about subject arises to which neither person knows the answer. This is the point when, in the prior art, one of the conversation participants would typically reach for their mobile telephone and perform an internet search for information about the subject in question. However, in this example one participant has an application already running on a mobile telephone that, according to the present invention, is continuously updating search engine results based subsets of words continuously extracted from their conversation. Therefore, now when the user picks up the mobile telephone and looks at the screen, there will already be displayed the search engine results generated by the most recent subset of words extracted from the conversation.

Most of the time, the information sought will be present on the first page of search results. Even if it is not, it is likely that the search query used based on the most recent subset of words extracted from the conversation is very close to the ideal search query for the subject in question. Therefore, if the user must make an additional input into the mobile telephone to generate the desired search results, the user will only be required to make a minor adjustment, perhaps the addition of a single word, instead of generating the entire search query from scratch.

### EXAMPLE 2

### Sports Score Module

In this example, the same conditions are present as in Example 1, except that the processor-executable instructions comprise at least one module for delivering content to the user, including a default internet search engine module and a sports score module. When the application is run, the ASR begins translating the speech captured through the microphone into text, and the subsets of words are continuously extracted from the speech, the subsets are analyzed for any mention of sports or sports teams. As long as the conversation stays off the subject of sports, the content that is updated and delivered to the user will be updated and delivered by the default internet search engine module. However, as soon as the name of a sport or a sports team is mentioned, the sports score module will continuously update and deliver the content to the user. For example, the sports score determined by the instructions to be most relevant to the conversation will be delivered in column and row format generally similar to the format used by television broadcasts of sporting events.

### EXAMPLE 3

### Sports Score Module with Location-Specific Information

In this example, the same conditions are present as in Example 2, except that the processor-executable instructions utilize location-specific information on the mobile telephone to update and deliver content to the user. Here, one participant in the conversation may ask, “Did you see the score of the baseball game last night?” The inventive instructions in this example may assume that because the mobile telephone is located in the area of San Francisco, Calif. (based on the telephone's GPS coordinates) as the conversation is taking place, that the most relevant score will be the score of the San Francisco Giants game that was played the previous night. Therefore, the sports score module will deliver the score of the most recent Giants game in a format that is familiar to sports fans.

The number and scope of other potential implementations of this technology are large and varied. A television, computer or mobile telephone could be programmed with the inventive instructions described herein to continuously update content based on speech captured from a live television or radio broadcast, such as a news program or sporting event. For example, the inventive instructions could have a music module that uses the microphone of an electronic device to capture the songs playing on the radio and continuously update the song title, album, artist or other information about the song.

For pre-recorded television or radio shows, the speech can be converted to text prior to the show airing to reduce the processor load in continuously updating content based on the information delivered by the pre-recorded show.

In the conversational implementations of this technology, the speech captured by the instructions, the subsets of words used to continuously update the content, and or the content itself, can be aggregated for a given area or time period, and be used to show a user or users trends in language usage or content.

It will now be evident to those skilled in the art that there has been described herein a method and system for continuously capturing ambient speech and using it to update content delivered to a user. Although the invention hereof has been described by way of preferred embodiments, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

In sum, while this invention has been particularly shown and described with reference to a preferred embodiment, it will be understood by those skilled in the art that various changes, in form and detail may be made therein without departing from the spirit and scope of the invention.

What is claimed is:

1. A computer-readable-recordable storage medium storing processor-executable instructions that when executed by a processor perform:
continuously capturing, through a microphone operatively coupled to a mobile computing device, substantially all human speech in range of said microphone;
converting said speech to text using automatic speech recognition;
continuously extracting subsets of words from said text;
delivering content to a user of said mobile computing device based at least in part on at least one said subset of words; and
continuously updating said content based at least in part on changes in said subsets of words.

2. The computer-readable-recordable medium of claim 1 wherein said content comprises internet search results.

3. The computer-readable-recordable medium of claim 1 wherein said delivering is based at least in part on non-speech information derived from said mobile computing device.

4. The computer-readable-recordable medium of claim 1 wherein said updating comprises refining said content while said speech remains on a first topic, and replacing said content when said speech pivots to a second topic.

5. The computer-readable-recordable medium of claim 1 wherein said subsets consist essentially of at least one of nouns, verbs, adjectives, adverbs and proper names.

6. The computer-readable-recordable medium of claim 1 wherein a grammar specification used by said automatic speech recognition is updated based at least in part on said content and optionally at least in part on predictive search terms received from an internet search engine.

7. The computer-readable-recordable medium of claim 1 wherein said continuously capturing further comprises continuously capturing human speech received by said mobile computing device from a remote source.

8. The computer-readable-recordable medium of claim 1 wherein said content is delivered by a content-specific module.

9. The computer-readable-recordable medium of claim 1 wherein said content comprises a language trend.

10. A mobile computing device comprising the computer-readable-recordable storage medium of claim 1.

11. Processor-executable instructions that when executed by a processor perform:
continuously capturing, through a microphone operatively coupled to a mobile computing device, substantially all human speech in range of the microphone;
converting said speech to text using automatic speech recognition;
continuously extracting subsets of words from said text;
delivering content to a user of said mobile computing device based at least in part on at least one said subset of words; and
continuously updating said content based at least in part on changes in said subsets of words.

12. A method of updating content and delivering content to a user of a mobile computing device comprising:
continuously capturing, through a microphone operatively coupled to said mobile computing device, substantially all human speech in range of said microphone;
converting said speech to text using automatic speech recognition;
continuously extracting subsets of words from said text;
delivering said content to a user of said mobile computing device based at least in part on at least one said subset of words; and
continuously updating said content based at least in part on changes in said subsets of words.
